(19) United States
(12) Patent Application Publication
(10) Pub. No.: US 2005/0142369 A1
(43) Pub. Date: Jun. 30, 2005

(54) Compound formable decorative laminate door panel

(76) Inventors: Virgil B. Canady, Temple, TX (US); Billy Joe Billeck JR., Rogers, TX (US); Finian E. Hoelscher, Temple, TX (US); Michael E. Ingrim, Belton, TX (US); Robert R. Krebs, Georgetown, TX (US)

Correspondence Address: WILSONART INTERNATIONAL, INC.;C/O WELSH & FLAXMAN, LLC, 2450 JEFFERSON DAVIS HIGHWAY, SUITE 112, ARLINGTON, VA, 22202, US

(21) Appl. No.: 11/041,274

(22) Filed: Jan. 25, 2005

Related U.S. Application Data
(63) Continuation-in-part of application No. 10/845,068, filed on May 14, 2004.
(63) Continuation-in-part of application No. 09/683,735, filed on Feb. 7, 2002.

(51) Int. Cl. E04B 2/00; B32B 27/42

(52) U.S. Cl. 428/503; 428/506; 156/71

(57) ABSTRACT

A decorative laminate door panel includes a compound formable decorative laminate including a resin impregnated decorative layer composed of a bilaterally stretchable decorative sheet and a resin impregnated core layer composed of a bilaterally stretchable kraft paper. The door panel also includes a substrate to which the decorative laminate is bound.

### CROSS REFERENCE TO RELATED APPLICATION

This application is a continuation-in-part of U.S. patent application Ser. No. 10/845,068, filed May 14, 2004, entitled “COMPOUND FORMABLE DECORATIVE LAMINATE”, which is currently pending, and a continuation-in-part of U.S. patent application Ser. No. 09/683,735, filed Feb. 7, 2002, entitled “COMPUND FORMABLE DECORATIVE LAMINATE”, which is currently pending.

### BACKGROUND OF THE INVENTION

1. Field of the Invention

The invention relates to decorative laminate door panels. More particularly, the invention relates to the use of compound formable decorative laminates, which are composed of resin impregnated kraft and decorative papers, in the manufacture of decorative laminate door panels.

2. Description of the Prior Art

As the ability to replicate natural material with decorative laminates has substantially improved over the years, decorative laminates have found widespread use. For example, decorative laminates have replaced natural materials in the construction of countertops, furniture, store fixtures, signage, column wraps, appliance fronts, push and kick plates, ceiling panels, residential cabinetry, wall panels, decorative trim and accents for restaurant/food service equipment.

The laminate industry is continually striving to improve the functionality of decorative laminates. The advances in decorative laminate manufacturing make these materials equal to, or better than, the materials they are designed to replace.

Decorative laminates generally include plural layers of synthetic resin impregnated paper sheets bonded under heat and pressure to form a unitary structure. In normal practice, a decorative laminate sheet assembly, from the bottom up, includes a core layer of one or more phenolic resin impregnated sheets, above which lies a decorative melamine impregnated sheet. The decorative sheet may be further covered with a melamine impregnated overlay.

A substrate may also be bound to the decorative laminate to impart rigidity thereto. The substrate may be a pre-cured plastic laminate, such as glass fiber-reinforced thermoset polyester resin laminates and the like, a wood product, such as hardboard, wood waste or particle boards, plywood and the like, a mineral base board, such as, cement-asbestos board, sheet rock, plaster board, and the like, or a combination of substrates.

Decorative laminates are generally manufactured by placing the resin impregnated core and decorative sheet between steel plates and subjecting the laminate stack to heat and pressure for a time sufficient to consolidate the laminate and cure the resins. The pressure and heat force the resin in the paper sheets to flow, cure, and consolidate the sheets into a unitary laminated mass referred to in the art as a decorative high pressure laminate. Finally, the formed decorative laminate is bonded to a reinforcing substrate, such as, plywood, hardboard, asbestos board, particle board or the like.

Decorative laminates have previously found use in the manufacture of door panels. The decorative laminates are secured to the facing surfaces of the door panel. The resilience and durability of decorative laminates make them an ideal alternative to coated steel facings and natural wood doors.

Traditional door panel surfacing materials are not always well suited for the demands imposed by the environments in which the door panels are used. For example, materials such as vinyls, powder coatings, paint, low basis weight papers, wood veneers and solid woods have been used in the manufacture of door panels. All of these materials have surface properties that are in many ways inferior to decorative laminates. This includes cost, stain resistance, impact resistance, heat resistance, and scratch/scuff resistance.

However, the resins and papers utilized in the manufacture of prior decorative laminates limit one's ability to alter the shape of the cured decorative laminate (that is, through subsequent forming processes). This is not to say that decorative laminates are unbending and totally unsuited for any application requiring that the decorative laminate be formed around a non-planar surface. Currently available decorative laminates are, however, limited in their ability to be “wrapped” about substrates having substantial surface variations.

As such, the usefulness of decorative laminates in the manufacture of door panels is limited to door panels having limited curved surfaces. This is an important factor as many consumers prefer doors with a variety of surface facets and aesthetically pleasing designs.

Prior to the development of the compound formable decorative laminate disclosed in U.S. patent application Ser. No. 09/683,735, entitled “COMPOUND FORMABLE DECORATIVE LAMINATE”, filed Feb. 7, 2002, and U.S. patent application Ser. No. 10/845,068, entitled “COMPOUND FORMABLE DECORATIVE LAMINATE”, filed May 14, 2004, both of which are currently pending and incorporated herein by reference, those skilled in the art were unable to develop a decorative laminate well suited for forming operations, although various techniques have been developed to compensate for conventional decorative laminate's inability to be formed about irregular and/or non-planar surfaces. These techniques have met with only limited success and fabricators of decorative laminate remain limited to post-forming decorative laminates in a very limited number of ways. The terms “compound formed”, “compound formable” and variations thereof are used throughout the body of the present specification to describe the molding of decorative laminates in a three-dimensional space not limited to a single axis, that is, about multiple axes and with differing curvatures and radii.

Specifically, and with the exception of the compound formable decorative laminate disclosed in the above referenced application, fabricators are currently only able to post-form decorative laminates about a single axis lying within a single plane (that is, two-dimensionally), for example, in the formation of work surface edges or unitary backsplash/work surface structures where the decorative laminate is post-formed about a single axis. That is, current post-forming techniques allow one to wrap decorative laminate about the edge of a countertop but are not sufficiently developed to permit wrapping of the laminate around a countertop corner. While it is possible to slightly compound form high pressure decorative laminate, this slight compound forming is highly limited and not appropriate for the vast majority of commercial purposes.

Current techniques limit the molding of decorative laminates in a three-dimensional space. It is the inventors' understanding that high pressure decorative laminate is currently being formed over/onto three-dimensional surfaces limited to those having a principle radii of curvature>1.27 cm. As such, highly contoured facing surfaces of door panels cannot take advantage of the durability, cost and pleasing appearance offered by decorative laminates due to the current unavailability of a decorative laminate which may be compound formed about the three-dimensionally based profiles required by these structures.

The development of the compound formable decorative laminate discussed above has made it possible to expand the useful applications of decorative laminate to the area of door panel manufacture. With this in mind, the present technique for manufacturing door panels with compound formable decorative laminate has been developed and has overcome many of the shortcomings of prior art techniques for forming door panels.

### SUMMARY OF INVENTION

It is, therefore, an object of the present invention to provide a decorative laminate door panel including a compound formable decorative laminate having a resin impregnated decorative layer composed of a bilaterally stretchable decorative sheet and a resin impregnated core layer composed of a bilaterally stretchable kraft paper. The panel also includes a substrate to which the decorative laminate is bound.

It is also an object of the present invention to provide a method of fabricating a compound formable decorative laminate door panel. The method is achieved by preparing a decorative sheet such that it is bilaterally stretchable, preparing a kraft paper such that it is bilaterally stretchable, impregnating the preprocessed kraft paper with a resin, layering the decorative sheet and the kraft paper upon a compound formable substrate and bonding the layered decorative sheet, kraft paper and substrate to form a panel.

It is another object of the present invention to provide a method of fabricating a compound formable decorative laminate door panel by layering a decorative sheet and a kraft paper upon a compound formable substrate and simultaneously consolidating and forming the layered decorative sheet, kraft paper and substrate under heat and pressure to form a panel.

Other objects and advantages of the present invention will become apparent from the following detailed description when viewed in conjunction with the accompanying drawings, which set forth certain embodiments of the invention.

### BRIEF DESCRIPTION OF DRAWINGS

FIG. 1 is a perspective view of a door panel formed in accordance with the present invention.

FIG. 2 is a cross sectional view of the door panel shown in FIG. 1.

FIG. 3 is a schematic of the present compound formable laminate in accordance with a first embodiment of the present invention.

FIG. 4 is a schematic of a compound formable decorative laminate with a substrate in accordance with the present invention.

FIGS. 5 and 6 show the pressing steps in accordance with a preferred embodiment of the present invention.

FIGS. 7, 8 and 9 show the molding steps in accordance with yet a further embodiment of the present invention.

FIGS. 10, 11 and 12 show the molding steps in accordance with still a further embodiment of the present invention.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limited, but merely as the basis for the claims and as a basis for teaching one skilled in the art how to make and/or use the invention.

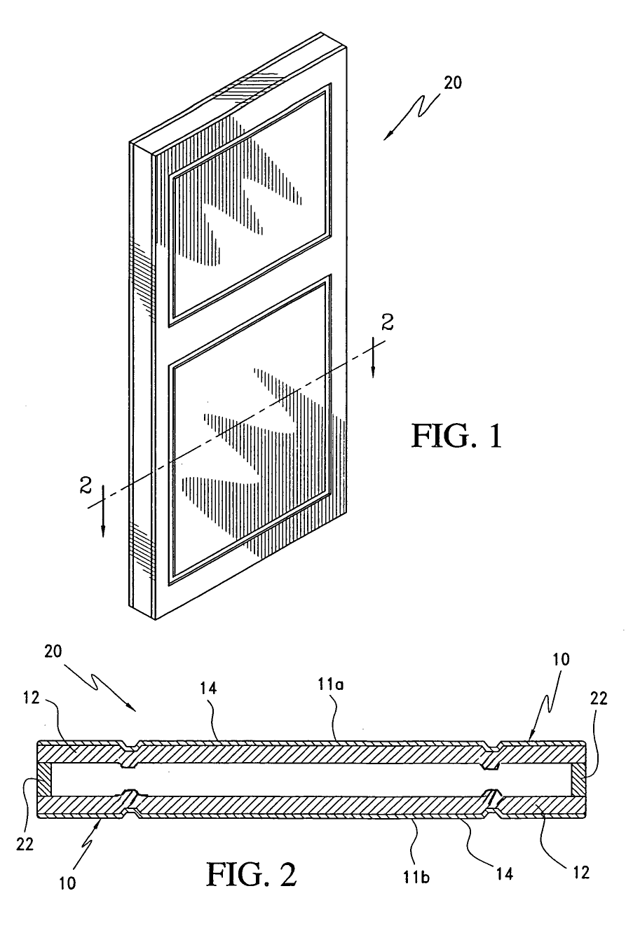

With reference to FIGS. 1 and 2, a door panel 10 manufactured in accordance with the present invention is disclosed. In accordance with a preferred embodiment of the present invention, door panels 10 form the outer surfaces 11a, 11b (with spacers 22 therebetween) of a complete door 20. The door 20 is assembled in a manner known to those skilled in the art. In addition, those skilled in the art will appreciate that the door panels may be utilized in other door constructions without departing from the spirit of the present invention.

The door panel 10 includes a substrate 12 upon which is formed a high pressure decorative laminate facing surface 14. In accordance with a preferred embodiment, both the substrate 12 and the high pressure decorative laminate facing surface 14 are compound formable. As such, and as will be discussed below in greater detail, the substrate 12 and decorative laminate facing surface 14 are preferably formed in a single step, although it is contemplated they may be formed individually for subsequent assembly.

Regardless of whether the decorative laminate facing surface 14 is formed in a single step process or a multiple step process, compression molding is the basic process utilized to produce decorative laminate facing surfaces 14 in accordance with the present invention. In general, the molding process employs a frame for transmitting generated loads to the ground, two heated platens capable of maintaining a platen temperature of up to 149° C. for all thermal loads placed between the platens, a method for applying pressure to the platens and a control system coordinating the activities of the cycle. The method for applying pressure must be able to achieve pressures up to 20.68 MPa over the nominal projected surface area of the decorative laminate facing surface 14.

The decorative laminate facing surface 14 in accordance with the present invention may be compound formed along three-dimensions, that is, a surface with two finite principle radii of curvature, via either expansion of the decorative laminate or contraction of the decorative laminate. As discussed above, the terms “compound formed”, “compound formable” and variations thereof are used throughout the body of the present specification to describe the molding of decorative laminates in a three-dimensional space not limited to a single axis, that is, about multiple axes and with differing curvatures and radii.

In accordance with a preferred embodiment of the present invention, the compound formable decorative laminate is that disclosed in U.S. patent application Ser. No. 09/683,735, entitled “COMPOUND FORMABLE DECORATIVE LAMINATE”, filed Feb. 7, 2002, or U.S. patent application Ser. No. 10/845,068, entitled “COMPOUND FORMABLE DECORATIVE LAMINATE”, filed May 14, 2004, both of which are incorporated herein by reference. However, those skilled in the art will appreciate that other compound formable decorative laminates may be employed without departing from the spirit of the present invention.

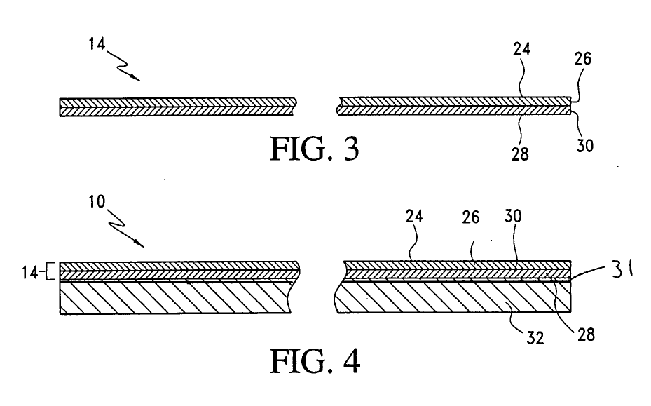

With this in mind and with reference to FIG. 3, a preferred compound formable decorative laminate facing surface 14 includes a resin impregnated decorative layer 24 composed of a bilaterally stretchable decorative paper 26 which may be stretched at least approximately 20% to 50% and a resin impregnated core layer 28 composed of at least one sheet of bilaterally stretchable kraft paper 30 which may be stretched at least approximately 20% to 50%. While specific ranges are disclosed above, papers which stretch as much as 100% are known in the prior art and could possibly be used in accordance with the present invention. The stretchable nature of the decorative paper 26 and the kraft paper 30 permits expansion and contraction of the decorative laminate facing surface 14 as the laminate is compound formed in the manner discussed below. In accordance with a preferred embodiment of the present invention, the compound formable decorative laminate facing surface 14 will include a single sheet of resin impregnated, bilaterally stretchable decorative paper 26 and a single sheet of resin impregnated, bilaterally stretchable kraft paper 30.

The laminate facing surface 14 is fabricated by preprocessing a decorative paper 26 such that it is bilaterally stretchable, impregnating the preprocessed decorative paper 26 with a resin, preprocessing a kraft paper 30 such that it is bilaterally stretchable, impregnating the preprocessed kraft paper 30 with a resin, layering the decorative paper 26 and the kraft paper 30 and consolidating the layered decorative paper 26 and kraft paper 30 under heat and pressure to form the sheet of decorative laminate facing surface 14. While a specific layering pattern is disclosed in accordance with a preferred embodiment of the present invention, the layering pattern may be varied, somewhat, without departing from the spirit of the present invention.

The decorative layer 24 is a decorative paper 26 positioned directly above the core layer 28. The decorative layer 24 is substantially responsible for the aesthetic appearance of the finished decorative laminate facing surface 14. Decorative layers may be chosen from a wide array of sheets. For example, the decorative layer may be a solid color (for example, white) or include an aesthetically appealing pattern.

As discussed above, the decorative layer 24 provides the laminate facing surface 14 with an attractive appearance. Where the decorative layer 24 forms the outer surface of the laminate facing surface 14, the decorative layer 24 will also dictate the surface characteristics of the final decorative laminate facing surface 14. For example, the composition of the decorative layer 24 helps to dictate the decorative laminate's resistance to chemical agents, heat, light, shock and abrasion.

In accordance with the present invention, the decorative layer 24 is composed of a single sheet of decorative paper 26. These decorative paper sheets are commonly manufactured from high quality 50-125 ream weight (80-202 grams per square meter), pigment filled, alpha cellulose paper impregnated with a water alcohol or water solution of melamine-formaldehyde resin. However, prior to impregnation with the resin, the decorative paper 26 is bilaterally creped in both the x and y directions. In accordance with a preferred embodiment of the present invention, the decorative paper 26 is creped using the x crepe system of Cindus, Inc. Specifically, x crepe describes a creping system in which crossing sets of creping crinkles diagonally disposed in the direction of the web are formed in a paper sheet. Sheets of this type, which are universally stretchable, have been made in accordance with the teachings of a number of patents including U.S. Pat. No. 2,008,181 Kemp, U.S. Pat. No. 2,008,182 Kemp, U.S. Pat. No. 2,071,347 Kemp, U.S. Pat. No. 2,399,256 Rowe, U.S. Pat. No. 2,567,967 Rowe, U.S. Pat. No. 2,610,935 Rowe, and U.S. Pat. No. 3,476,644 Krehnbrink. These sheets further provide for contraction or compression thereof due to the crinkled nature of the creping.

The creping process is described in detail in the foregoing patents. Briefly, the process comprises the steps of dunking the paper sheet in water, applying a resin to the sheet so that it will adhere to a drum and finally peeling the sheet off a drum with a blade that causes the paper to crinkle much like paint which is scraped from a surface. The creped decorative paper 26 is then impregnated with a water alcohol or water solution of melamine-formaldehyde resin. It has been found that the x creped decorative paper 26 used in accordance with a preferred embodiment of the present invention absorbs resin more slowly than the standard papers used in the industry. Papers suitable for x creping are generally sized, which reduces the saturability of the paper. As such, decorative paper sheets 26 with a resin content of only approximately 30% to 35% have been used in accordance with the present invention (conventional decorative sheets commonly have a resin content of approximately 50% or greater). The resulting surface performance is, however, similar to high pressure laminate incorporating standard papers with a resin content of 50%. The x creped decorative paper 26 in accordance with this embodiment of the present invention exhibits bilateral stretch of approximately 20% to 35%.

The resin impregnated decorative paper 26 is subsequently dried, partially cured, and finally cut into sheets. The pigment filled, alpha cellulose paper of the decorative paper sheet, may include a solid color, a decorative design, or a photo-gravure reproduction of natural materials, such as, wood, marble, leather, etc. The aesthetic characteristics of the cellulose paper are revealed as the laminate's decorative design upon completion of the decorative laminate facing surface 14.

The core layer 28 is preferably formed from at least one phenolic resin impregnated sheet of kraft paper 30, although other materials may be used without departing from the spirit of the present invention. The core layer 28 is constructed to be very thin so as to minimize the thickness of the resulting laminate facing surface 14, while similarly providing a stable structural member, and improve the compound formability of the resulting decorative laminate facing surface 14. With this in mind, and in accordance with a preferred embodiment of the present invention, the core layer 28 includes a single sheet of phenolic resin impregnated kraft paper 30. Before x creping the kraft paper 30 had a basis weight of 80 lb/ream (1 ream=3,000 ft²) or 129 grams per square meter, however, those skilled in the art will appreciate that the weight may be varied without departing from the spirit of the present invention.

While a single sheet of kraft paper is disclosed above in accordance with a preferred embodiment of the present invention, it has been found that multiple sheets of kraft paper may be used without departing from the spirit of the present invention. For example, 2 sheets of kraft paper produce very good results, while 3 and 4 sheet core layers are compound formable but do not produce the detail of thinner core layers. In accordance with previously tested embodiments of the present invention, a compound formable laminate including a single core sheet and a single decorative sheet has a thickness of approximately 0.483 mm, a compound formable laminate including two core sheets and a single decorative sheet has a thickness of approximately 0.737 mm, a compound formable laminate including three core sheets and a single decorative sheet has a thickness of approximately 1.054 mm in. and a compound formable laminate including four core sheets and a single decorative sheet has a thickness of approximately 1.422 mm.

As with the decorative paper 26 discussed above, the kraft paper 30 of the core layer 28 is creped to provide “crinkling” in both the x and y directions. The kraft paper 30 is also creped using the x crepe system of Cindus, Inc. The resulting x creped kraft paper 30 is capable of stretching to 20% to 50%.

The x creped kraft paper 30 is then impregnated throughout with a phenolic resin and is partially cured (β-staged). Resin contents between 32.0% and 50.0% have been used in the present invention. Resin contents between 32.0% and 36.0% are, however, preferred to minimize migration of phenolic resin through the decorative paper to the decorative surface.

While x creped kraft and decorative papers are disclosed in accordance with a preferred embodiment of the present invention, other creped papers offering bilateral stretching may be used in accordance with the present invention. For example, it is contemplated that Italian “moulding paper” may be used in accordance with the present invention. “Moulding paper” is a finely creped paper offering stretch characteristics required in accordance with the present invention. For example, Cartiere Cariolaro SpA and Gruppo X di X Gruppo manufacture such a paper. Information concerning the paper may be readily found at www.cariolaro.com/cariolaro/Eng//MouldPaper.htm.

The decorative laminate facing surface 14 is formed in much the same manner as conventional decorative laminates. The decorative and core layers 24, 28 are first stacked as a laminate lay-up and placed between steel plates. The laminate lay-up is then subjected to temperatures in the range of 110° C. to 155° C. and pressure of about 5.52 MPa to 11.03 MPa for a time sufficient to consolidate the laminate and cure the resins (generally about 25 minutes to an hour). The heat and pressure used generally correspond to a post-forming cycle or even a “greener” post-forming cycle. The time, temperature and pressure may be adjusted when only partially cured laminates are desired as discussed below in accordance with the various embodiments.

The pressure and heat force the resin in the paper sheets to flow, cure and consolidate the sheets into a unitary laminated mass referred to in the art as a high pressure decorative laminate. Generally, more than one laminate is formed at one time. Multiple laminates are formed by inserting a plurality of assembled sheets in a stack. Release sheets are positioned between the assembled sheets to separate the various laminates stacked together. After consolidation, the release sheets allow the individual laminates to be separated.

The decorative laminate facing surface 14 described above is used in the construction of a door panel 10 by forming the decorative laminate facing surface 14 to a desired three-dimensional configuration in the manner discussed below and securing the formed decorative laminate to a substrate 12, for example, of compound formable MDF. As discussed below in substantial detail, the decorative laminate facing surface 14 and the substrate 12 are formed and coupled using a one-step process. However, those skilled in the art will appreciate that multiple-step processes may be employed without departing from the spirit of the present invention.

The compound forming of the decorative laminate facing surface 14 is facilitated by the laminate's ability to both expand and contract without cracking or buckling during heating, forming and subsequent cooling. In accordance with a preferred embodiment of the present invention, and as discussed below in greater detail, an adhesive tie layer 31 is preferably positioned between the decorative laminate facing surface 14 and the substrate 32. Various adhesives may be used without departing from the spirit of the present invention. For example, the compound formable decorative laminate facing surface may be manufactured with an integral adhesive backing composed of an integral film or extensible paper layer coated with a suitable adhesive (e.g., PVA). Similarly, a traditional contact adhesive may be employed. Adhesives contemplated for use in accordance with a preferred embodiment of the present invention are EVA and PVA.

Although a decorative laminate facing surface composed of a melamine impregnated decorative sheet and a phenolic resin impregnated core layer is disclosed, other compound formable laminates may be employed without departing from the spirit of the present invention. For example, the compound formable decorative laminate facing surface may be similar to that disclosed in U.S. patent application Ser. No. 10/845,068, entitled “COMPOUND FORMABLE DECORATIVE LAMINATE”, filed May 14, 2004, which is incorporated herein by reference.

With reference to FIG. 4, a cross sectional view of a preferred door panel 10 is disclosed. In accordance with this embodiment, the decorative laminate facing surface 14 and the substrate 32 are formed at the same time; that is, via a one-step process.

More specifically, and in accordance with a preferred embodiment of the present invention, the compound formable laminate door panel 10 includes a resin impregnated decorative layer 24 composed of a bilaterally stretchable decorative paper 26, an impregnated core layer 28 composed of at least one sheet of bilaterally stretchable kraft paper 30 and a flexible medium density fiberboard (MDF) substrate 32.

The fiberboard substrate 32 used in accordance with this embodiment is approximately 0.3175 cm thick. In accordance with a preferred embodiment of the present invention, the fiberboard substrate 32 is MDF. The MDF is specially manufactured to permit forming thereof through the use of a match mold press. While the MDF is used in accordance with a preferred embodiment of the present invention, other similar formable MDFs may be used without departing from the spirit of the present invention.

It is contemplated that the substrate may also be constructed of a plurality of sheets of phenolic resin impregnated kraft paper. In accordance with this variation, the phenolic resin impregnated kraft paper used as a substitute for the MDF substrate would preferably be manufactured in the same manner as the formable, bilaterally stretchable kraft paper used in the manufacture of the compound formable decorative laminate discussed above. However, those skilled in the art will appreciate, that traditional phenolic resin impregnated kraft paper could be employed in applications where substantial forming of the substrate is not required.

The door panel 10 of the present embodiment is formed by stacking and forming the fiberboard substrate 32 and the consolidated laminate facing surface 14 with an adhesive tie layer 31 therebetween. More specifically, the door panel 10 includes an integral adhesive tie layer (or an extensible paper layer coated with a suitable adhesive) 31 composed of a film integrally associated with the decorative laminate facing surface 14. For example, and in accordance with a preferred embodiment of the present invention, the adhesive tie layer 31 is a low basis weight, overlay paper coated with PVA on the side that is exposed to the substrate 32. It is however, contemplated the adhesive tie layer may also take the form of a PVA-coated plastic film.

In accordance with an alternate embodiment of the present invention, and in situations where the compound formed laminate facing surface will require extra durability and/or impact resistance, the decorative laminate facing surface may be formed with an overlay sheet and/or additional x creped kraft sheets in the core layer. With regard to the overlay sheet, the overlay sheet is preferably a melamine impregnated paper sheet and is similarly treated to improve its stretch characteristics. Once pressed and heated to form a complete decorative laminate facing surface, the resin in the overlay paper layer forms a barrier preventing damage to the underlying decorative sheet. The overlay paper layer also dictates the surface characteristics of the final decorative laminate facing surface. For example, the composition of the overlay layer helps to dictate the decorative laminate's resistance to chemical agents, heat, light, shock and abrasion. As discussed in U.S. patent application Ser. No. 10/845,068, entitled “COMPOUND FORMABLE DECORATIVE LAMINATE”, filed May 14, 2004, which is incorporated herein by reference, the overlay could also be a 100% polyester sheet or polyester/rayon blend.

In those instances where it is determined that either an overlay sheet or additional core layer sheets should be incorporated into the laminate, it has been found that the formed laminate is still highly suited for compound forming as discussed above. However, it has also been found that such laminates are not quite capable of bending in radii as tight as with the two sheet laminate discussed above.

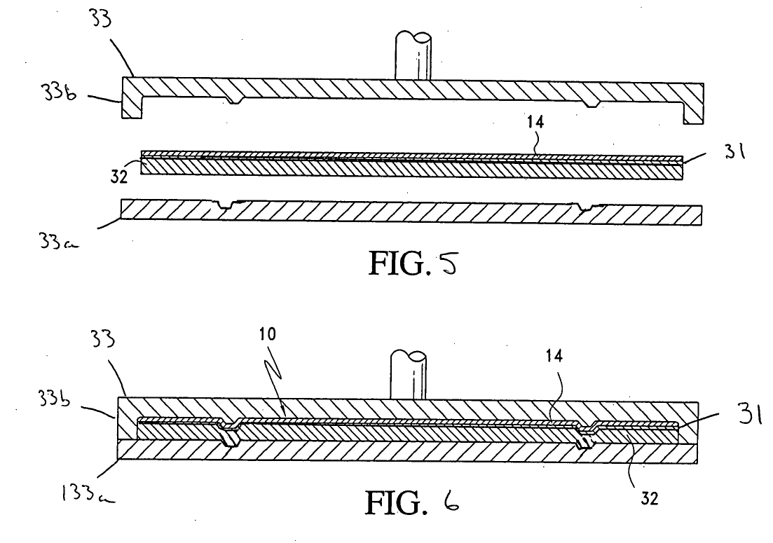

Various “one-step” processes are contemplated for application in the mass production of door panels. In accordance with a preferred embodiment and with reference to FIGS. 3, 4, 5 and 6, a one-step process for compression molding the decorative laminate door panels 10 is disclosed. In accordance with this embodiment, pre-bonded assemblies of the compound formable decorative laminate facing surface 14 and a 0.3175 cm MDF substrate 32 are employed. First, the consolidated decorative laminate facing surface 14, an adhesive tie layer 31 and the substrate 32 are pre-bonded using Wilsonart LW3000 PVA adhesive to form a pre-compression decorative laminate door panel assembly. In accordance with a preferred embodiment of the present invention, non-decorative side of the laminate facing surface 14 and one side of the substrate 32 are coated with approximately 0.076 mm (wet) of the adhesive to form the adhesive tie layer 31.

The pre-compression decorative laminate door panel assembly is then pressed by positioning a piece of plywood upon the top of the assembly and allowing the adhesive tie layer 31 to dry/set-up overnight. However, those skilled in the art will appreciate the hot pressing operation could also be used without departing from the spirit of the present invention. More particularly, the hot and cold pressing operations used in accordance with the present invention are traditional pressing techniques. As those skilled in the art will certainly appreciate, the choice between cold or hot pressing is determined based upon various operational constraints considering that hot pressing is generally quicker and cold pressing can be employed in the bonding of multiple assemblies during a single pressing operation.

Once the pre-compression decorative laminate door panel assembly is formed, door skin matched molds 33a, 33b are attached to molding press platens 33. In accordance with a preferred embodiment of the present invention, the matched molds 33a, 33b have feature depths of approximately 1.27 cm, although it could be deeper. The press platens 33 are heated to 138° C. and held at this condition. The matched molds 33a, 33b are allowed to reach a steady-state surface temperature of approximately 135° C. before pressing.

The pre-bonded decorative laminate door panel assembly described above is then placed MDF-side down onto the lower matched mold 33a to pre-heat. The panel is removed when the opposite (decorative) face reaches a temperature of approximately 93.3° C. The MDF-side of the door panel assembly is then misted with water and returned to its position against the lower matched mold 33a. The press platen 33 is then closed over a period of approximately 20 second, reaching a maximum effective pressure on the panel of approximately 15.00 MPa. The press platen 33 is held at this condition for approximately 60 second and opened. It should be noted that this process requires no degassing. Thereafter, the formed decorative laminate door panel 10 is retrieved and should exhibit good conformity to the matched mold 33a, 33b. There should be no blistering, cracking, distortion, delamination, discoloration, or telegraphing of either the bond line or substrate.

In accordance with a variation of the process described above, the decorative laminate facing surface described above includes two phenolic core layers. Similar positive results are obtained by substituting a decorative laminate facing surface that has only one phenolic core layer, again with no degassing step. Here, it was possible to reduce the press closing time to 60 seconds with a maximum effective panel pressure of 10.00 MPa.

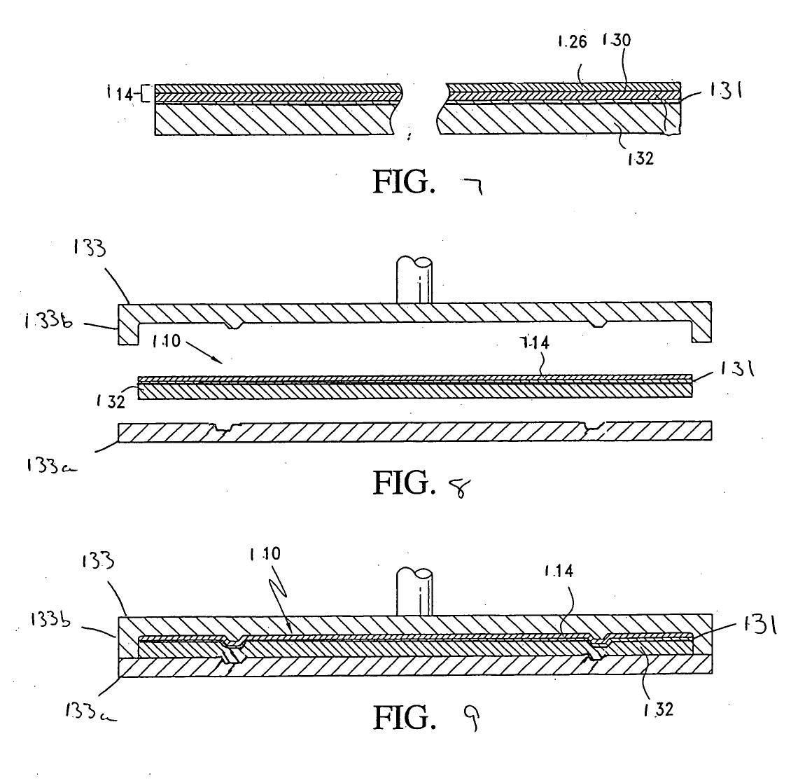

In accordance with a still further embodiment, and with reference to FIGS. 7, 8 and 9, the decorative laminate door panel 110 is formed utilizing a one-step process with an adhesive film 131 positioned between the consolidated compound formable decorative laminate facing surface 114 and the substrate 132. As with the process described above, the door skin matched molds 133a, 133b are attached to molding press platens 133. The press platens 133 are heated to 138° C. and held at this condition. The matched molds 133a, 133b are allowed to reach a steady-state surface temperature of approximately 135° C. before pressing. One or both faces of the substrate 132 are then heated to a temperature of approximately 93.3° C., for example, using the platen press type heating device 133. One or both of the substrate 132 faces are misted with water such that one or both of the surfaces are covered with fine water droplets. Thereafter, the adhesive film 131 is placed onto the substrate 132 and the unconsolidated layers 126, 130 of the decorative laminate facing surface 114 (in much the same manner as a laminate lay-up) are placed on top of the adhesive film 131. This three-component precompression decorative laminate door panel assembly is then place between the match mold halves 133a, 133b in the heated platen press 133. The heated platen press 133 is closed at a rate sufficient to produce the formed decorative laminate door panel 110 without tear outs, fractures etc. In accordance with a preferred embodiment, the closing time is approximately two (2) minutes with peak nominal pressure between approximately 10.00 MPa to 15.00 MPa. The platen press 133 is maintained at peak pressure for a time sufficient to assure complete plastic deformation of the decorative laminate door panel 110 and bonding of the substrate 132 to the decorative laminate facing surface 114 via the tie layer of adhesive film 131. In accordance with a preferred embodiment, the hold time ranges from approximately 45 seconds to approximately 60 seconds. The platen press 133 is then opened and the formed decorative laminate door panel 110 is retrieved.

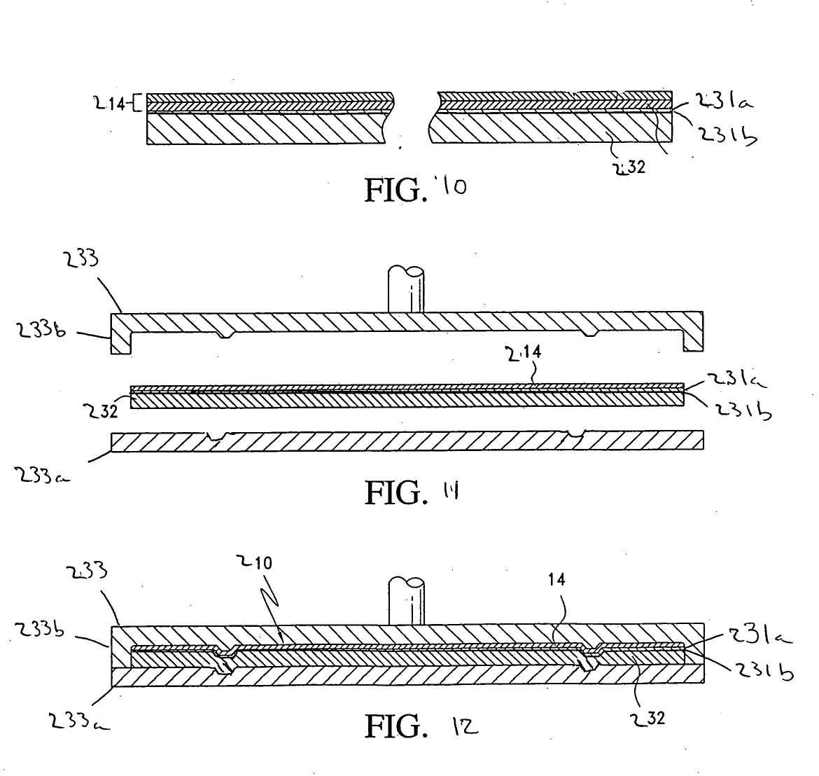

In accordance yet a further embodiment, and with reference to FIGS. 10, 11 and 12 the decorative laminate door panel 210 is formed via a one-step process wherein an applied adhesive is positioned between the consolidated compound formable decorative laminate facing surface 214 and the substrate 232. In accordance with this embodiment, a suitable contact adhesive 231a is rolled or sprayed upon the non-decorative side of the decorative laminate facing surface 214. The contact adhesive 231b is also applied to one side of the substrate 232. In accordance with a preferred embodiment, the contact adhesive is EVA or PVA. Once applied, the coated surfaces of the respective decorative laminate facing surface 214 and the substrate 232 are allowed to partially dry. The non-coated side of the substrate 232 is then heated to a temperature of approximately 93.3° C. using a platen press type heating device 233. The non-coated side of the substrate 232 is then misted with water such that the surface is covered with fine water droplets. Thereafter, the non-decorative side of the decorative laminate facing surface 214, that is, the side of the decorative laminate facing surface 214 coated with adhesive, is placed onto the coated side of the substrate 232. The pre-compression decorative laminate door panel assembly is then positioned between the two halves 233a, 233b of a matched mold in a heated platen press 233. The platen press 233 is closed at a rate sufficient to produce the formed piece without tear outs, fractures, etc. In accordance with a preferred embodiment, the closing time for the press is approximately two (2) minutes with peak nominal pressure between approximately 10.00 MPa and 15.00 MPa on the decorative laminate door panel. The platen press 233 is maintained at peak pressure for a time sufficient to assure complete plastic deformation of the decorative laminate door panel 210 and bonding of the substrate 232 to the decorative laminate facing surface 214. In accordance with a preferred embodiment, the hold time ranges from approximately 45 seconds to approximately 60 seconds. Thereafter, the platen press 233 is opened and the formed decorative laminate door panel 210 is retrieved.

As briefly mentioned above with reference to the second embodiment, it is contemplated the decorative laminate facing surface may be pressed with the substrate as a traditional laminate lay-up composed of a plurality of unconsolidated separate sheets. It is believed this technique will speed processing by minimizing the steps required before pressing and may accordingly be applied to the other embodiments disclosed in accordance with the present invention. Similarly, it is contemplated the decorative laminate facing surface may be processed as a low pressure laminate prior to compound forming with the substrate.

While the preferred embodiments have been shown and described, it will be understood that there is no intent to limit the invention by such disclosure, but rather, is intended to cover all modifications and alternate constructions falling within the spirit and scope of the invention as defined in the appended claims.

1. A decorative laminate door panel, comprising:
a compound formable decorative laminate including a resin impregnated decorative layer composed of a bilaterally stretchable decorative sheet and a resin impregnated core layer composed of a bilaterally stretchable kraft paper; and
a substrate to which the decorative laminate is bound.

2. The decorative laminate door panel according to claim 1, wherein the decorative layer is impregnated with a melamine resin.

3. The decorative laminate door panel according to claim 1, wherein the core layer is impregnated with a phenolic resin.

4. The decorative laminate door panel according to claim 1, wherein the decorative sheet is x creped so as to impart stretchability thereto.

5. The decorative laminate door panel according to claim 1, wherein the kraft paper is x creped so as to impart stretchability thereto.

6. The decorative laminate door panel according to claim 1, wherein the decorative sheet is capable of being stretched at least approximately 20%.

7. The decorative laminate door panel according to claim 1, wherein the kraft paper is capable of being stretched at least approximately 20%.

8. The decorative laminate door panel according to claim 1, wherein the substrate is medium density fiberboard.

9. The decorative laminate door panel according to claim 8, wherein the substrate is compound formable.

10. The decorative laminate door panel according to claim 1, wherein substrate is compound formable.

11. A method of fabricating a compound formable decorative laminate door panel, comprising:
preparing a decorative sheet such that it is bilaterally stretchable;
preparing a kraft paper such that it is bilaterally stretchable;
impregnating the preprocessed kraft paper with a resin;
layering the decorative sheet and the kraft paper upon a compound formable substrate; and
bonding the layered decorative sheet, kraft paper and substrate to form a panel.

12. The method according to claim 11, further including the step of impregnating the decorative sheet with a melamine resin.

13. The method according to claim 11, wherein the step of impregnating the kraft paper includes impregnating the kraft paper with a phenolic resin.

14. The method according to claim 11, wherein the step of preparing the decorative sheet includes x creping so as to impart stretchability thereto.

15. The method according to claim 11, wherein the step of preparing the kraft paper includes x creping so as to impart stretchability thereto.

16. The method according to claim 11, wherein the prepared decorative sheet is capable of being stretched at least approximately 20%.

17. The method according to claim 11, wherein the prepared kraft paper is capable of being stretched at least approximately 20%.

18. The method according to claim 11, wherein the substrate is medium density fiberboard.

19. The method according to claim 11, further including the step of consolidating the decorative sheet and the kraft paper prior to the step of layering.

20. The method according to claim 19, wherein the step of bonding includes pressing the decorative sheet, kraft paper and substrate under heat and pressure to form a panel.

21. The method according to claim 20, wherein the step of layering includes positioning a tie layer between the kraft paper and the substrate.

22. The method according to claim 20, wherein the step of bonding includes simultaneously pressing and forming the decorative sheet, kraft paper and substrate.

23. The method according to claim 11, wherein the step of layering includes positioning a tie layer between the kraft paper and the substrate.

24. A method of fabricating a compound formable decorative laminate door panel, comprising:
layering a decorative sheet and a kraft paper upon a compound formable substrate; and
simultaneously consolidating and forming the layered decorative sheet, kraft paper and substrate under heat and pressure to form a panel.
